(19) United States
(12) Patent Application Publication
(10) Pub. No.: US 2022/0241791 A1
(43) Pub. Date: Aug. 4, 2022

(54) SPECIMEN CUP HOLDER AND ILLUMINATION DEVICE

(71) Applicant: Paul Guarino, Yorktown, VA (US)

(72) Inventor: Paul Guarino, Yorktown, VA (US)

(21) Appl. No.: 17/162,389

(22) Filed: Jan. 29, 2021

(51) Int. Cl. B01L 9/00

(52) U.S. Cl. CPC B01L 9/00; B01L 2300/06; B01L 2300/168

(57) ABSTRACT

A specimen cup holder and illumination device includes a first container, a second container, and a light source. The first container has a translucent bottom, opaque sides, an opaque top, and compartments defined therein. Each compartment includes a portion of the translucent bottom, portions of the opaque sides, and at least one opaque interior wall spanning between the translucent bottom and opaque top. The opaque top has specimen cup-receiving holes with each hole being in communication with one of the compartments. The second container has an open top and a closed bottom, and is configured to slidingly receive a portion of the first container therein so that the translucent bottom is suspended above the closed bottom. The light source is disposed in the second container between the translucent bottom of the first container and the closed bottom of the second container.

### FIELD OF THE INVENTION

The invention relates generally to specimen cup holders, and more particularly to a device that holds multiple biopsy specimen cups while providing for illumination thereof such that biopsy specimens can be readily visualized in dark treatment room environments.

### BACKGROUND OF THE INVENTION

A variety of medical diagnoses are based on the analysis of human tissue specimens collected from internal regions of a patient. In many cases, the collected specimens are miniscule pieces of tissue collected using very small tools or instruments passed through an endoscope.

Medical procedures that utilize endoscopes are generally conducted in dark rooms so that attending medical personnel can clearly see images transmitted by the endoscope to a display being closely monitored by medical personnel carrying out the procedure. Each collected specimen is passed to an attending nurse or technician who must then place the specimen in a specimen cup. Combining miniscule specimen collection in a dark room with the desire to minimize the length of an endoscopic procedure frequently results in specimen collection issues to include loss of specimens and the inability to verify if a specimen is actually in a specimen cup.

### SUMMARY OF THE INVENTION

Accordingly, it is an object of the present invention to provide a device that aids in the human tissue specimen collection process that takes place during an endoscopic procedure.

Another object of the present invention is to provide a device that can be used in a dark endoscopic-procedure room to improve the process of human tissue specimen collection and verification.

Other objects and advantages of the present invention will become more obvious hereinafter in the specification and drawings.

In accordance with the present invention, a specimen cup holder and illumination device includes a first container, a second container, and a light source. The first container has a translucent bottom, opaque sides, and an opaque top. The first container has a plurality of compartments defined therein that span between the translucent bottom and opaque top. Each compartment includes a portion of the translucent bottom, portions of the opaque sides, and at least one opaque interior wall spanning between the translucent bottom and opaque top. The opaque top has a plurality of holes wherein each hole is in communication with one of the compartments. Each hole is adapted to receive a biopsy specimen cup therein. The second container has an open top and a closed bottom, and is configured to slidingly receive a portion of the first container therein via its open top thereof wherein the translucent bottom is disposed in the second container and is suspended above the closed bottom thereof. The light source is disposed in the second container between the translucent bottom of the first container and the closed bottom of the second container.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a perspective view of a specimen cup holder and illumination device in accordance with an embodiment of the present invention;

FIG. 2 is a cross-sectional view of the device taken along 2-2 in FIG. 1;

FIG. 3 is a top plan view of the device illustrated in FIG. 1 with its opaque top omitted therefrom;

FIG. 4 is an isolated longitudinal cross-sectional view of the device's top container illustrated in FIG. 1;

FIG. 5 is a cross-sectional view of the device's bottom container illustrated in FIG. 1;

FIG. 6 is an exploded perspective view of the device's top container having a removable top in accordance with another embodiment of the present invention;

FIG. 7 is an isolated perspective view of the top container of a specimen cup holder and illumination device having a non-illuminated specimen-manipulating tool holder in accordance with another embodiment of the present invention;

FIG. 8 is a longitudinal cross-sectional view of the top container illustrated in FIG. 7;

FIG. 9 is a cross-sectional view of the device's bottom container in accordance with another embodiment of the present invention; and

FIG. 10 is an isolated plan view of the ledge-forming removable end wall of the bottom container illustrated in FIG. 9.

### DETAILED DESCRIPTION OF THE INVENTION

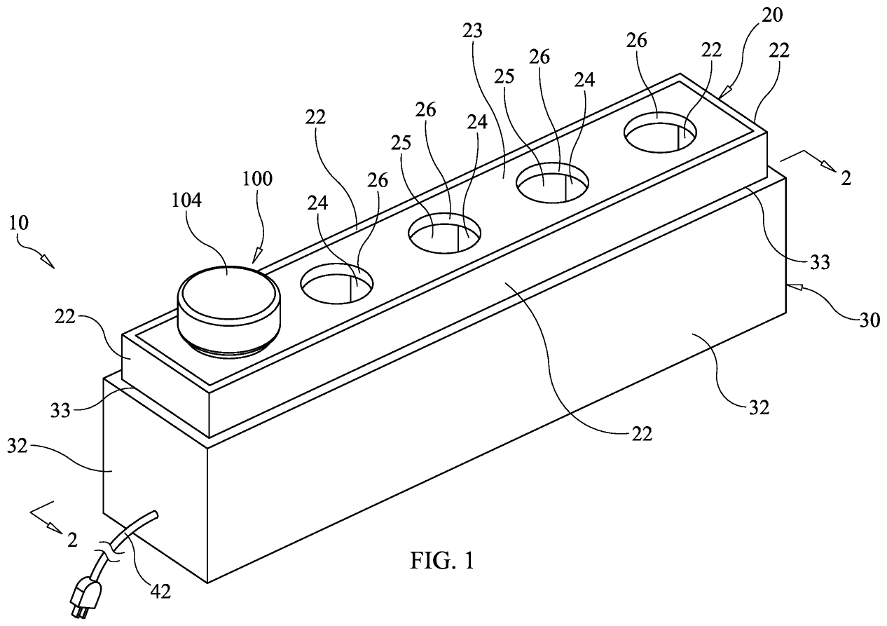

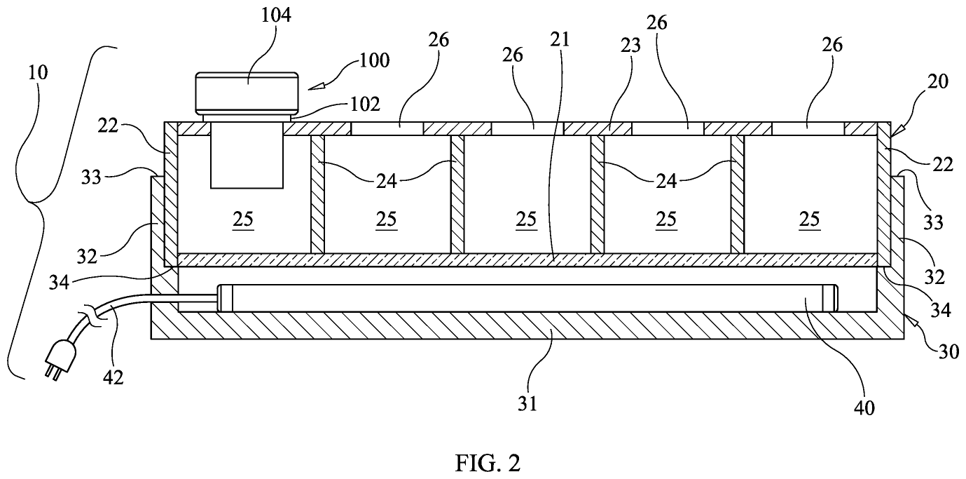

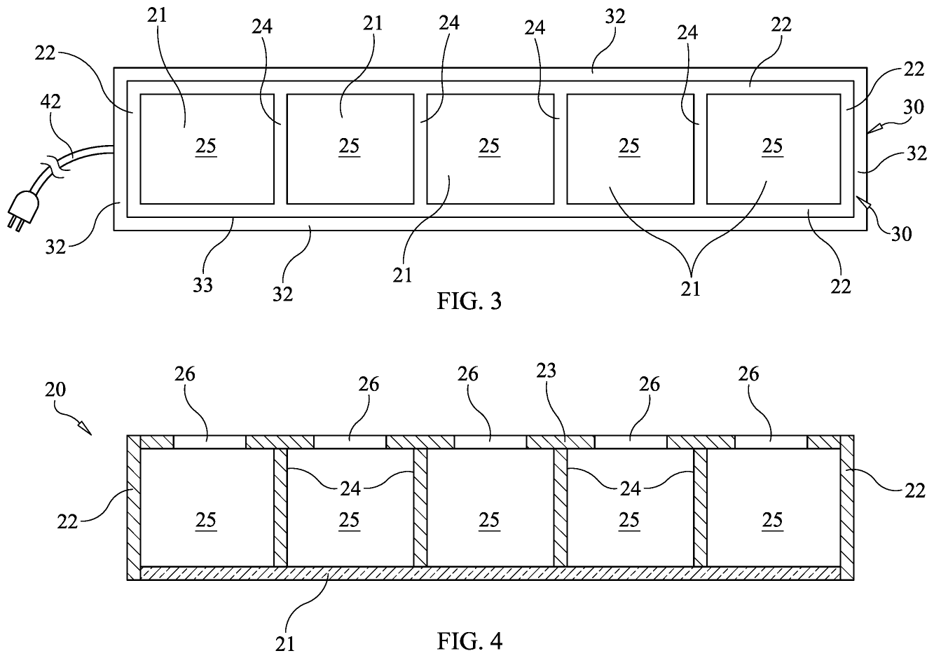

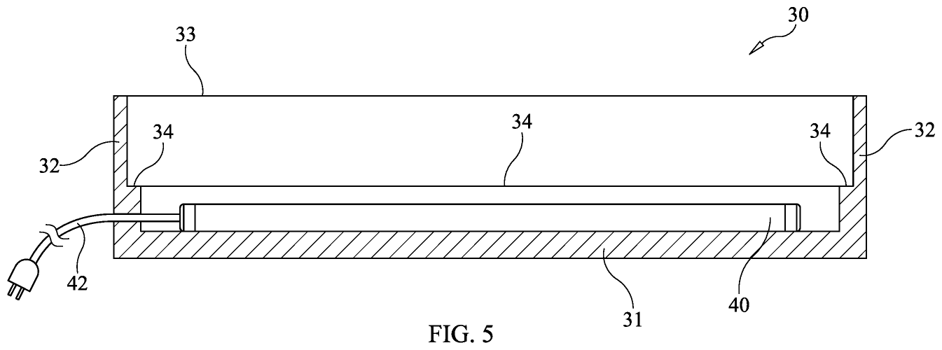

Referring now to the drawings, simultaneous reference will be made to FIGS. 1-5 where a specimen cup holder and illumination device is illustrated in its entirety in FIGS. 1-2 and in portions thereof in FIGS. 3-5. The entire device is referenced generally by numeral 10 in FIGS. 1-2. As will be explained further herein, device 10 simultaneously holds and illuminates multiple specimen cups in which human tissue specimens are placed during an endoscopic procedure. In FIGS. 1 and 2, a typical specimen cup 100 is shown being supported in device 10.

Device 10 includes two containers 20 and 30, and a light source 40. Briefly, container 20 (also referred to herein as the “top container”) holds/supports one or more specimen cups (e.g., specimen cup 100), and container 30 (also referred to herein as the “bottom container”) holds/supports top container 20 and light source 40. As will be explained further below, when light source 40 is turned on to generate light, any specimen cup held in top container 20 is back-lit with diffuse light.

Top container 20 is a generally rigid container made from one or more materials suitable for use in a medical setting where such materials are readily cleaned and disinfected in accordance with established guidelines and procedures. In the illustrated embodiment, top container 20 is generally rectangular in shape. However, it is to be understood that top container 20 could be realized by other geometric shapes without departing from the scope of the present invention.

Top container 20 is constructed to have a translucent bottom 21, opaque sides 22, and an opaque top 23. Top 23 can be fixed in place or can be removable from top container 20 as will be explained further below. Disposed within top container 20 are a number of interior walls 24 (e.g., four in the illustrated embodiment). Each interior wall 24 is opaque and spans between translucent bottom 21 and opaque top 23 as well as between opposing ones of the top container's long sides 22. As a result, a number of optically isolated compartments 25 are defined within top container 20 where each compartment 25 includes a portion of translucent bottom 21.

Opaque top 23 has a number of through holes 26 with each hole 26 positioned to communicate with one of compartments 25. Each hole 26 is sized/shaped to receive a specimen cup therein. Since specimen cups, such as specimen cup 100, generally have an outer annular flange 102 to provide for sealing engagement with the cup's top 104, holes 26 are sized/shaped such that flange 102 rests on top 23 as illustrated. Top container 20 can be sized such that the bottom of specimen cup 100 is suspended above translucent bottom 21 as flange rests on top 23.

Bottom container 30 is also a generally rigid container made from one or more materials suitable for use in a medical setting for purposes of cleaning, disinfecting, etc. The shape/size of bottom container 30 is predicated on that of top container 20. In general, bottom container 30 is an open-top container configured to slidingly receive a portion of top container 20 therein to include its translucent bottom 21 such that translucent bottom is spaced from the closed bottom of bottom container 30. More specifically, bottom container 30 has a closed opaque bottom 31 and opaque sides 32 with its open top 33 sized/shaped to slidingly receive a portion of top container 20 therein. Bottom container 30 also has an interior annular ledge 34 on which top container 20 rests so that translucent bottom 21 is suspended above closed bottom 31.

Light source 40 is disposed in bottom container 30 in the region thereof beneath translucent bottom 21. In the illustrated embodiment, light source 40 is an elongated light source that generates light substantially all along the length of translucent bottom 21 such that light is generated beneath each of compartments 25. The generated light is diffused by translucent bottom 21 before it illuminates each of compartments 25. Light source 40 can be powered via an electric power cord 42 led into bottom container 30 as illustrated. However, the present invention is not so limited as light source 40 could also be battery-powered without departing from the scope of the present invention. In general, minimal or no heat should be generated by light source 40 when turned on to prevent heat build-up within device 10 that could negatively impact the tissue specimens being collected. Accordingly, suitable lights for light source 40 include fluorescent lights, LED lights, or any light source that generates minimal or no heat.

In use, one or more specimen cups are placed in holes 26 and light source 40 is turned on. The light produced by source 40 is diffused by translucent bottom 21 so that the specimen cups are back lit with diffuse light. In this way, when a specimen cup's top is removed, the contents of the specimen cup are evenly illuminated for viewing by a technician. At the same time, the generated light is predominantly contained within device 10 thereby preventing the light from negatively impacting the surrounding procedure environment and personnel.

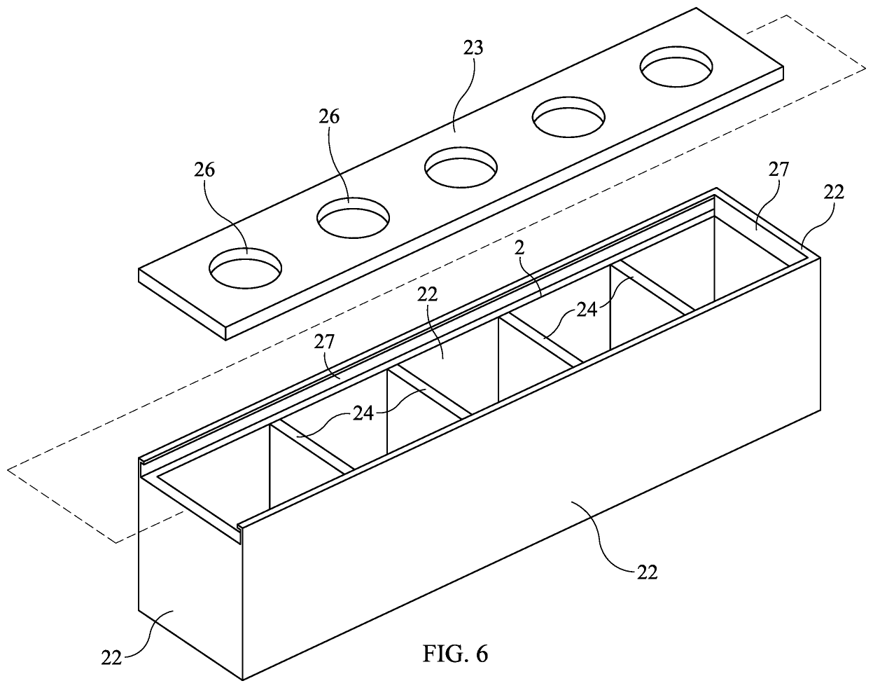

As mentioned above, the opaque top 23 of top container 20 can be made removable to simplify the cleaning/disinfecting thereof, to provide for ease of its replacement, and/or provide for tops 23 having holes 26 of varying size to accommodate different sizes of specimen cups. For example and as illustrated in FIG. 6, an open-ended slot 27 can be formed in the top regions of three of opaque sides 22 such that opaque top 23 can be readily slid into and out of slot 27. When fully inserted in slot 27, top 23 has the same attributes described previously herein where each hole 26 is aligned with one of compartments 25. It is to be understood that top 23 can be made removable in other ways without departing from the scope of the present invention.

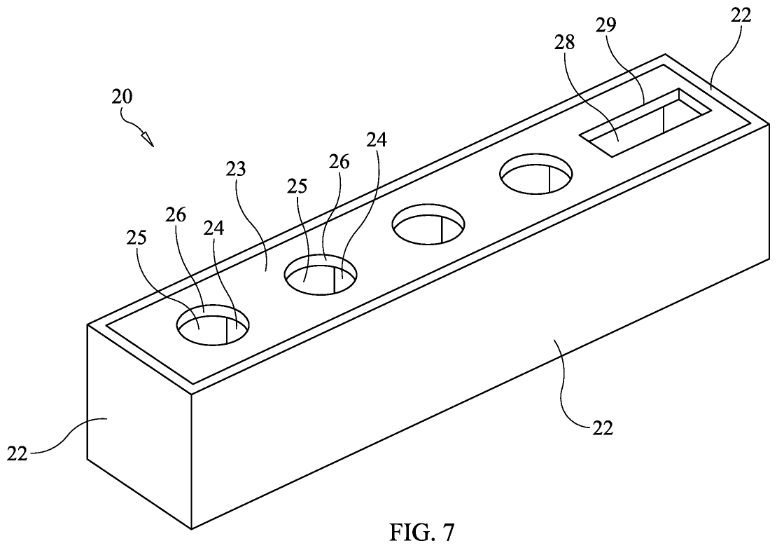

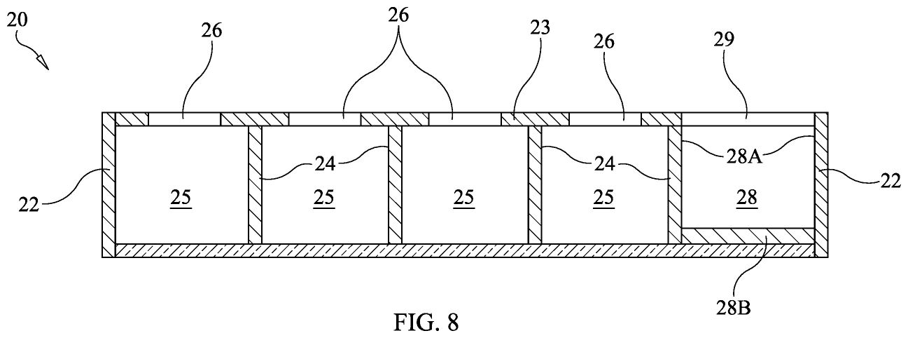

Another embodiment of the top container of the present invention is illustrated in FIGS. 7-8 wherein common reference numerals are used for those elements previously described herein. In this embodiment of top container 20, an additional compartment 28 is provided in top container 20 to provide a place to store/hold one or more specimen-manipulating tools commonly used by a technician tasked with populating specimen cups during an endoscopic procedure. More specifically, compartment 28 is accessed via a hole 29 in opaque top 23. Compartment 28 is constructed in a way that keeps it optically isolated from translucent bottom 21 as well as any adjacent compartment 25 in order to prevent light from entering and escaping from compartment 28 via hole 29. For example, in the illustrated embodiment, compartment 28 is defined by opaque sides 28A (i.e., sides 28A can be shared with or realized by one or more of opaque sides 22 and interior walls 24) and an opaque bottom 28B that prevent light from being passed into compartment 28 via translucent bottom 21. The shape/size of compartment 28 and its access hole 29, as well as how it is constructed for optical isolation, are not limitations of the present invention.

The advantages of the present invention are numerous. The specimen cup holder and illumination device allows multiple specimen cups to be simultaneously supported, while allowing a single cup whose top is removed to be illuminated with diffuse light so that miniscule tissue specimens can be readily placed and verified during an endoscopic procedure. By trapping nearly all light within the device, the preferred dark room environment of an endoscopic procedure can be maintained thereby ensuring the efficacy and efficiency of the procedure. Since a specimen-handling technician can readily verify specimen collection, an endoscopic procedure can proceed quickly to minimize patient trauma. The device is easily disassembled (for cleaning) and reassembled without the need for any tools.

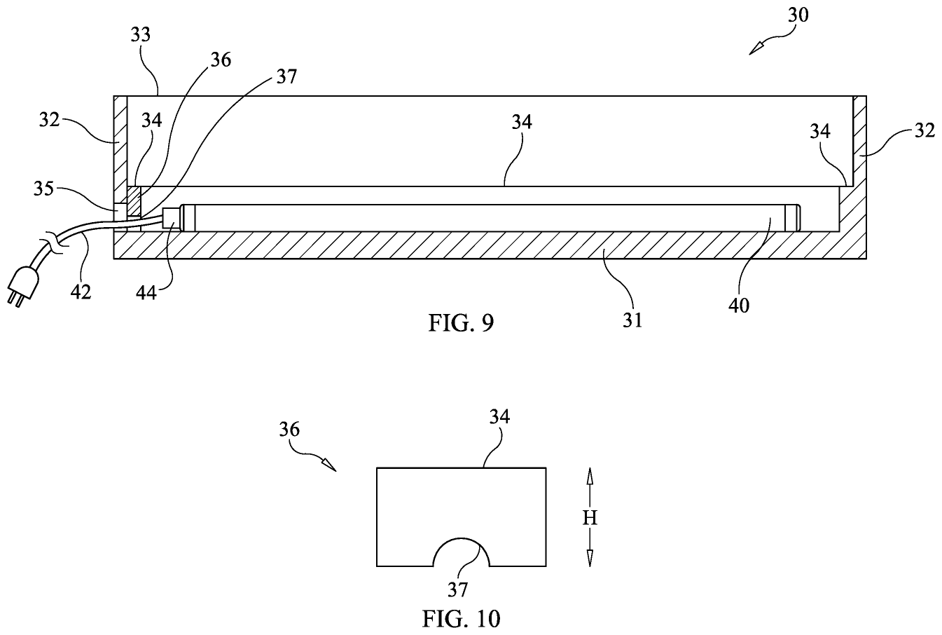

Although the invention has been described relative to a specific embodiment thereof, there are numerous variations and modifications that will be readily apparent to those skilled in the art in light of the above teachings. For example and with reference to FIGS. 9 and 10, another embodiment of bottom container 30 and light source 40 (FIG. 9) provides for removal of light source 40 to facilitate a complete cleaning of bottom container 30. More specifically, light source 40 has its power cord 42 terminating in removable plug 44 attachable to light source 40. Since plug 44 will generally be larger in diameter than power cord 42, a hole 35 in side 32 must be large enough to allow plug 44 to pass there through. Unfortunately, a hole 35 sized in this fashion will also allow light from light source 40 to escape from bottom container 30 which can serve as a distraction during a medical procedure as described above. To prevent this, a removable opaque end wall 36 (shown in isolation in FIG. 10) is notched or is cut out at 37 to snugly fit over power cord 42 just before it passes through hole 35. That is, notch/cutout 37 has a smaller size/diameter than that of hole 35 so that minimal light will escape through hole 35 when light source 40 is illuminated. The height “H” of end wall 36 is such that the top thereof aligns with and becomes part of annular ledge 34 when end wall 36 abuts a side 32 and faces into bottom container 30 as illustrated. It is therefore to be understood that, within the scope of the appended claims, the invention may be practiced other than as specifically described.

What is claimed as new and desired to be secured by Letters Patent of the United States is:

1. A specimen cup holder and illumination device, comprising:
a first container having a translucent bottom, opaque sides, and an opaque top, said first container having a plurality of compartments defined therein and spanning between said translucent bottom and said opaque top, wherein each of said compartments includes a portion of said translucent bottom, portions of said opaque sides, and at least one opaque interior wall spanning between said translucent bottom and said opaque top, said opaque top having a plurality of holes wherein each of said holes is in communication with one of said compartments, each of said holes adapted to receive a biopsy specimen cup therein;
a second container having an open top and a closed bottom, said second container made from opaque materials and configured to slidingly receive a portion of said first container therein via said open top thereof wherein said translucent bottom is disposed in said second container and is suspended above said closed bottom thereof; and
a light source disposed in said second container between said translucent bottom of said first container and said closed bottom of said second container.

2. A device as in claim 1, wherein said opaque top is removably coupled to said first container.

3. A device as in claim 1, wherein said opaque top is slidingly engaged with said first container.

4. A device as in claim 1, wherein said second container includes a ledge on which said first container rests.

5. A device as in claim 1, wherein said second container includes:
an outer side wall having a hole extending there through; and
a removable inner side wall abutting said outer side wall, said inner side wall having a notch aligned with said hole, said notch having a smaller diameter than that of said hole.

6. A device as in claim 1, further comprising an open-top receptacle disposed in said first container and optically isolated from said translucent bottom.

7. A device as in claim 1, wherein said light source is disposed beneath each of said compartments.

8. A specimen cup holder and illumination device, comprising:
a first container having a translucent bottom, opaque sides, and a removable opaque top, said first container having a plurality of compartments defined therein, each of said compartments including a portion of said translucent bottom, portions of said opaque sides, a portion of said removable opaque top, and at least one opaque interior wall, said removable opaque top having a plurality of holes wherein each of said holes is in communication with one of said compartments, each of said holes adapted to receive a biopsy specimen cup therein wherein a bottom of the biopsy specimen cup is suspended above said translucent bottom;
a second container having an open top and a closed bottom, said second container made from opaque materials and configured to slidingly receive a portion of said first container therein via said open top thereof wherein said translucent bottom is disposed in said second container and is suspended above said closed bottom thereof; and
a light source disposed in said second container between said translucent bottom of said first container and said closed bottom of said second container for illuminating said translucent bottom beneath each of said compartments.

9. A device as in claim 8, wherein said removable opaque top is slidingly engaged with said first container.

10. A device as in claim 8, wherein said second container includes an annular ledge on which said first container rests.

11. A device as in claim 8, wherein said second container includes:
an outer side wall having a hole extending there through; and
a removable inner side wall abutting said outer side wall, said inner side wall having a notch aligned with said hole, said notch having a smaller diameter than that of said hole.

12. A device as in claim 8, further comprising an open-top receptacle disposed in said first container and optically isolated from said translucent bottom.

13. A device as in claim 8, wherein said light source is disposed beneath each of said compartments, and is selected from the group consisting of fluorescent lights and LED lights.

14. A specimen cup holder and illumination device, comprising:
a first container having a translucent bottom, opaque sides, and an opaque top, said first container having a plurality of first compartments and a second compartment defined therein,
each of said first compartments being optically isolated from one another and including a portion of said translucent bottom, portions of said opaque sides, a portion of said opaque top, and at least one opaque interior wall,
said second compartment being optically isolated from said first compartments and said translucent bottom,
said opaque top having a plurality of first holes and a second hole, wherein each of said first holes is in communication with one of said first compartments and said second hole is in communication with said second compartment, each of said first holes adapted to receive a biopsy specimen cup therein;
a second container having an open top and a closed bottom, said second container made from opaque materials and configured to slidingly receive a portion of said first container therein via said open top thereof wherein said translucent bottom is disposed in said second container and is suspended above said closed bottom thereof; and
a light source disposed in said second container between said translucent bottom of said first container and said closed bottom of said second container for illuminating said translucent bottom beneath each of said first compartments.

15. A device as in claim 14, wherein said opaque top is removably coupled to said first container.

16. A device as in claim 14, wherein said opaque top is slidingly engaged with said first container.

17. A device as in claim 14, wherein said second container includes an annular ledge on which said first container rests.

18. A device as in claim 14, wherein said second container includes:
an outer side wall having a hole extending there through; and
a removable inner side wall abutting said outer side wall, said inner side wall having a notch aligned with said hole, said notch having a smaller diameter than that of said hole.

19. A device as in claim 14, wherein said light source is disposed beneath each of said compartments, and is selected from the group consisting of fluorescent lights and LED lights.
